(19) United States
(12) Patent Application Publication
(10) Pub. No.: US 2008/0145594 A1
(43) Pub. Date: Jun. 19, 2008

(54) Removable Carpet Fringe

(76) Inventor: Connie J. Jewell, Benton Harbor, MI (US)

Correspondence Address: DYKEMA GOSSETT PLLC, 10 S. WACKER DR., STE. 2300, CHICAGO, IL, 60606, US

(21) Appl. No.: 11/611,614

(22) Filed: Dec. 15, 2006

(51) Int. Cl. B32B 3/06; B32B 3/02

(52) U.S. Cl. 428/100; 428/115; 428/99

(57) ABSTRACT

An apparatus is disclosed. The apparatus comprises a first side portion, a second side portion, a first end portion, a second end portion, at least a first fringe portion and at least a second fringe portion. Each of the first side portion and the second side portion are disposed in a parallel relationship with each other. Each of the first end portion and the second end portion are disposed in a parallel relationship with each other and in a perpendicular relationship with each of the first side portion and the second side portion. The first fringe portion is disposed on at least the first end portion. The first fringe portion is disposed on an edge of the first end portion away from the center of the apparatus. The first fringe portion is disposed in communication with the first end portion through a first communication means. The second fringe portion is disposed on at least the second end portion. The second fringe portion is disposed on an edge of the second end portion away from the center of the apparatus. The second fringe portion is disposed in communication with the second end portion through a second communication means. The first fringe portion is capable of being removed from the first end portion in a non-destructive fashion, and the second fringe portion is capable of being removed from the second end portion in a non-destructive fashion.

### FIELD OF THE PRESENT INVENTION

The Present Invention relates to carpets and rugs having fringe thereon and, more particularly, to carpets and rugs having fringe thereon which is able to be removed and replaced.

### BACKGROUND OF THE PRESENT INVENTION

Carpets have been used for many years, both for aesthetic and practical reasons. Prior to the 18^{th} Century, carpets were primarily used for aesthetic reasons to cover up blemishes on walls and windows (which were not usually glass-enclosed), or even as ornate table coverings. However, carpets gradually were used for application on floors. Nevertheless, they retained their aesthetic appeal.

Part of the aesthetic appeal includes the fringe that traditionally appears at the ends of the carpet. Carpet fringe refers to the loose strands of cloth, fibers, or similar material, extending outward from the carpet. Because of its nature, carpet fringe frequently becomes soiled and/or damaged, and must often be cleaned and/or repaired. Unfortunately, repeated cleaning and/or repairing may render the carpet fringe in a depleted state, that is, unkempt, deteriorating or, even, permanently stained. Further, as carpet fringe represents strands of material which are, in fact, used in the preparation and manufacture of the carpet, they cannot easily be removed without causing damage to the carpet itself.

Thus, there exists the need for a removable carpet fringe which overcomes the disadvantages listed above.

### SUMMARY OF THE PRESENT INVENTION

The Present Invention overcomes the deficiencies listed above by providing a removable carpet fringe which will allow a user to remove and replace soiled or worn-out fringe. To this end, an apparatus is disclosed.

In one embodiment, the Present Invention discloses an apparatus, which comprises a first side portion, a second side portion, a first end portion, a second end portion, a first fringe portion and a second fringe portion. Each of the first side portion and the second side portion are disposed in a parallel relationship with each other. Each of the first end portion and the second end portion are disposed in a parallel relationship with each other and in a perpendicular relationship with each of the first side portion and the second side portion. The first fringe portion is disposed on a first end portion. The first fringe portion is disposed on an edge of the first end portion away from the center of the apparatus. The first fringe portion is disposed in communication with the first end portion through a first communication means. The second fringe portion is disposed on a second end portion. The second fringe portion is disposed on an edge of the second end portion away from the center of the apparatus. The second fringe portion is disposed in communication with the second end portion through a second communication means. The first fringe portion is capable of being removed from the first end portion in a non-destructive fashion, and the second fringe portion is capable of being removed from the second end portion in a non-destructive fashion.

In another embodiment, the Present Invention discloses an apparatus, which comprises a first side portion, a second side portion, a first end portion, a second end portion, a first display surface, a second display surface, a first non-display surface, a second non-display surface, a first fringe portion, a second fringe portion, a first communication means, and a second communication means. Each of the first side portion and the second side portion may be disposed in a parallel relationship with each other. Each of a first end portion and a second end portion may be disposed in a parallel relationship with each other, and in a perpendicular relationship with each of the first side portion and the second side portion. The first end portion has a first display surface and a first non-display surface, each of the first display surface being configured to be substantially displayed and the first non-display surface being configured to be substantially unseen. The second end portion has a second display surface and a second non-display surface, the second display surface being configured to be substantially displayed and the second non-display surface being configured to be substantially unseen. A first fringe portion may be disposed on the first display surface of the first end portion, and may be on an edge of the first display surface away from the center of the apparatus. The first fringe portion connected with the first end portion through a first communication means. The first communication may be hidden from view by being disposed on the first non-display surface. A second fringe portion may be disposed on the second display surface of the second end portion. The second fringe portion may be disposed on an edge of the second display surface away from the center of the apparatus. The second fringe portion may be connected with the second end portion through a second communication means. The second communication means may be disposed on the second non-display surface and hidden from view. The first fringe portion is capable of being removed from the first end portion in a non-destructive fashion, and the second fringe portion is capable of being removed from the second end portion in a non-destructive fashion.

### BRIEF DESCRIPTION OF THE FIGURES

FIG. 1 illustrates a top view of one embodiment of an apparatus, constructed in accordance with the teachings of the Present Invention;

FIG. 2 illustrates a close-up view of one embodiment of an attachment/detachment means for use with the apparatus of FIG. 1;

FIG. 3 illustrates a close-up view of a second embodiment of an attachment/detachment means for use with the apparatus of FIG. 1; and

FIG. 4 illustrates a top view of one embodiment of an apparatus, with an upturned portion.

### DETAILED DESCRIPTION OF THE PRESENT INVENTION

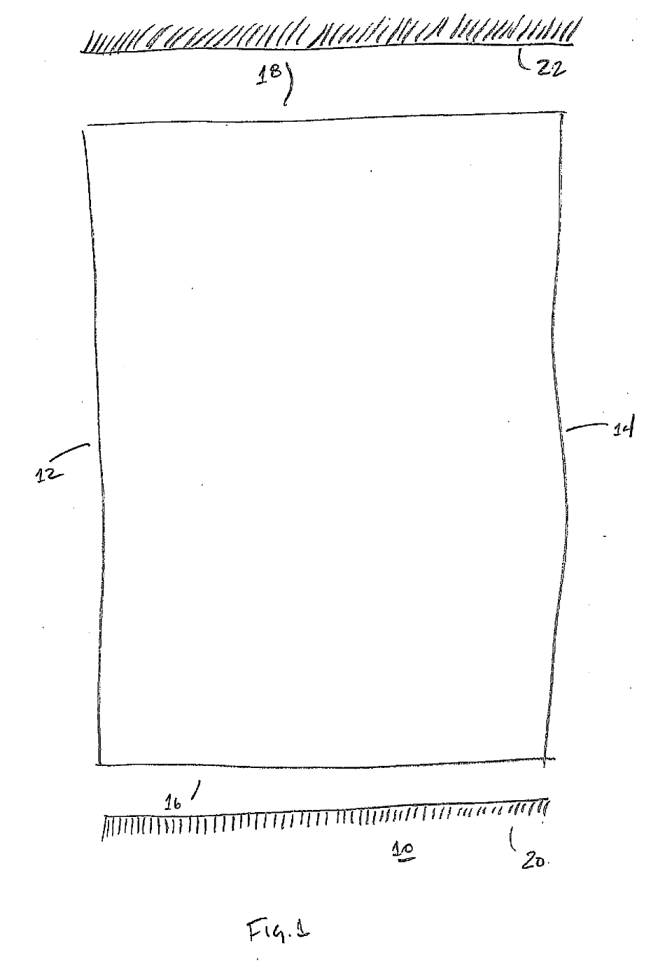

Referring to the Figures, in which like numerals refer to like elements, apparatus 1 0, as constructed in accordance with one embodiment of the Present Invention, is illustrated. Referring specifically to FIG. 1, apparatus 10 generally comprises first side portion 12, second side portion 14, first end portion 16, second end portion 18, first fringe portion 20 and second fringe portion 22.

Preferably, apparatus 10 comprises a carpet, or, more specifically, a rug. For purposes of the Present Invention, a rug and a carpet are to be considered similar devices, that being, floor coverings, differing only in the aspect that a carpet is meant to cover the floor in its entirety, while a rug is meant to cover a portion of the floor. Generally speaking, both carpets and rugs comprise any loom-woven, felted textile or grass-based device meant to be used as a floor covering. Alternatively, apparatus 10 may comprise a carpet- or rug-like device that, instead of being intended for use as a floor covering, is used as any other type of covering, such as, for example, a table covering (e.g., a table cloth), a wall covering (e.g., a tapestry) or a window covering (e.g., a curtain). Finally, it is preferred, although not necessary, that apparatus 10 be in the shape of a quadrilateral polygon (i.e., a rectangle or a square), however, it is contemplated that apparatus 10 comprise any shape.

Based on the illustration in FIG. 1, first side portion 12 and second side portion 14 refer to the sides of apparatus 10 that are not—in this embodiment—adaptable for receiving first fringe portion 20 or second fringe portion 22. If apparatus 10 is a quadrilateral polygon having two pairs of sides of equal length (i.e., a rectangle), then first side portion 12 and second side portion 14 additionally refer to the two longer sides.

Although it is contemplated that the entirety of the edge of apparatus 10 be adaptable for receiving fringe portions—or any portion thereof, in FIG. 1, first end portion 16 and second end portion 18 refer to the sides of apparatus 10 that are adaptable for receiving first fringe portion 20 or second fringe portion 22. If apparatus 10 is a quadrilateral polygon having two pairs of sides of equal length (i.e., a rectangle), then first end portion 16 and second end portion 18 additionally refer to the two shorter sides.

First side portion 12 and second side portion 14 are disposed in a roughly parallel relationship to each other. Likewise, first end portion 16 and second end portion 18 are also disposed in a roughly parallel relationship to each other. These relationships are “roughly” parallel because any imperfections in the creation of apparatus 10 may result in a relationship that is not exactly parallel; in this case, a rough parallel relationship is sufficient. Additionally, as is consistent with the nature of quadrilateral polygons, the angles between first side portion 12 and first end portion 16, first side portion 12 and second end portion 18, second side portion 14 and first end portion 16, and second side portion 14 and second end portion 18 comprise right angles.

First fringe portion 20 and second fringe portion 22 are preferably disposed at the edge of first end portion 16 and second end portion 18, respectively. That is, it is preferred that first fringe portion 20 and second fringe portion 22 are disposed at the very end of first end portion 16 and second end portion 18, respectively, as opposed to any other location within first end portion 16 and second end portion 18.

It is preferred that first fringe portion 20 and second fringe portion 22 be configured to be removable from first end portion 16 and second end portion 18, respectively, of apparatus 10. In this way, one of the objects of the Present Invention may be achieved; that being, the ability to remove and replace the fringe portions of a carpet or rug.

As contemplated by the objects of the Present Invention, removal and replacement of first fringe portion 20 and second fringe portion 22 is contemplated to be by any currently known attachment/detachment means 24, such as, for example, zippers, fabric hook-and-loop fasteners, snaps, buttons, any available male-and-female fastening systems or any other element or combination of elements that would result in an attachment/detachment means which is non-destructive in nature.

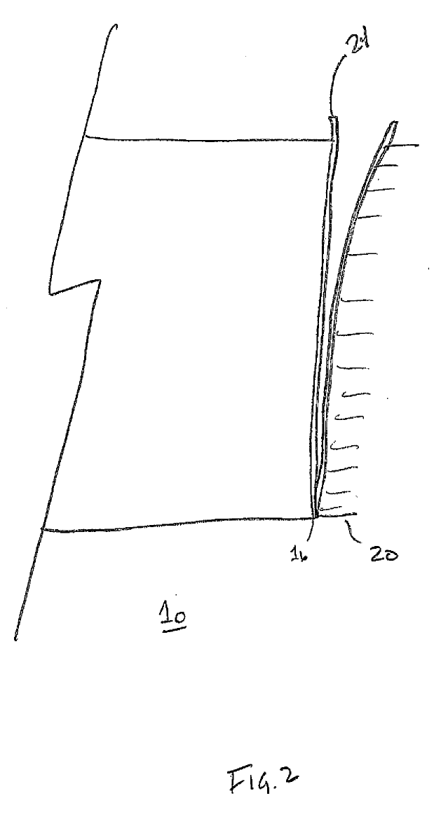

In essence, then, the attachment/detachment means is intended to allow a removal of an “old” first fringe portion 20 and an “old” second first fringe portion 22, and the attachment of a “new” first fringe portion 20 and a “new” second fringe portion 22. In the embodiment illustrated in FIG. 2, attachment/detachment means 24 is illustrated as a zipper.

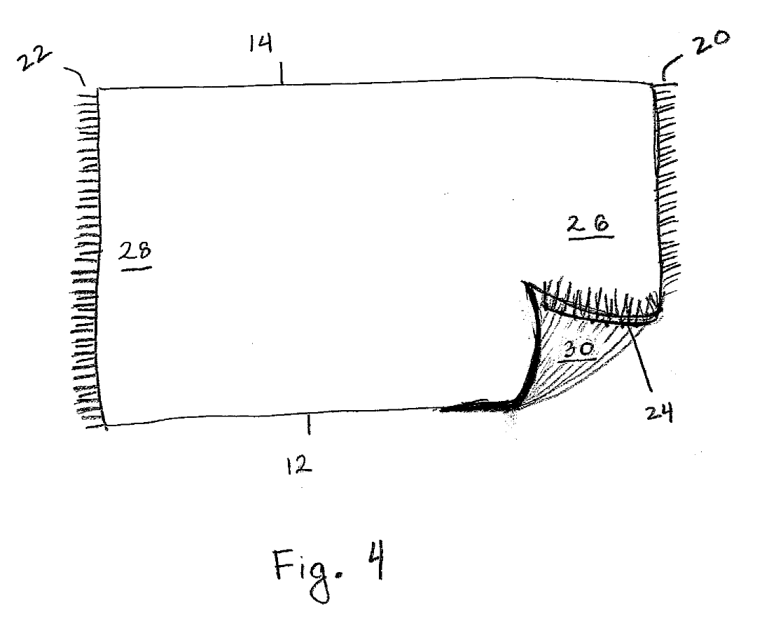

It is also preferred that the attachment/detachment means 24 be configured in the combination of first fringe portion 20 and first end portion 16, as well as second fringe portion 22 and second end portion 18, in a manner so as to shield the attachment/detachment means 24 from normal view of apparatus 10. Thus, in the example illustrated in the embodiment of FIG. 2, attachment/detachment means 24 is preferably configured so that, when apparatus 10 is placed on the floor, it is almost impossible to discern the fact that attachment/detachment means 24 is either being used with apparatus 10 or that attachment/detachment means 24 is a zipper. In the example illustrated in the embodiment of FIG. 4, a first display surface 26 is shown and a second display surface 28 is shown. Further, attachment/detachment means 24 is shown on first non-display surface 30, concealing attachment/detachment means 24 yet allowing first fringe portion 20 to be viewed. This concealment may also be accomplished by, the presence of a flap member—or other similar portion—that is disposed on apparatus 10 in an effort to conceal attachment/detachment means 24, or any other known means of concealment.

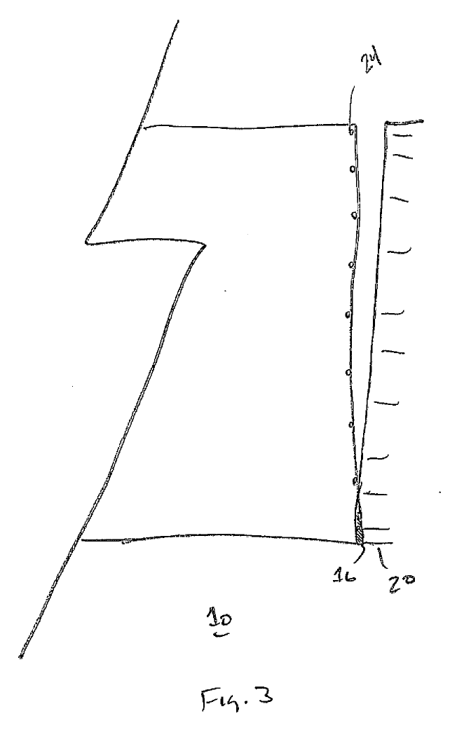

The embodiments shown in FIG. 3 illustrates a second possibilities for attachment/detachment means 24. For example, in FIG. 3, it is illustrated that attachment/detachment means 24 comprises a plurality of snaps.

While only those embodiments set forth above have been described in detail, other configurations and embodiments for the Present Invention exist that are within the spirit and scope of the Present Invention.

What is claimed is:

1. An apparatus comprising:
a first side portion and a second side portion, each of the first side portion and the second side portion being disposed in a parallel relationship with each other;
a first end portion and a second end portion, each of the first end portion and the second end portion being disposed in a parallel relationship with each other and in a perpendicular relationship with each of the first side portion and the second side portion;
a first fringe portion disposed on the first end portion, the first fringe portion being disposed on an edge of the first end portion away from the center of the apparatus, the first fringe portion disposed in communication with the first end portion through a first communication means; and
a second fringe portion disposed on the second end portion, the second fringe portion being disposed on an edge of the second end portion away from the center of the apparatus, the second fringe portion disposed in communication with the second end portion through a second communication means;
wherein the first fringe portion is capable of being removed from the first end portion in a non-destructive fashion, and the second fringe portion is capable of being removed from the second end portion in a non-destructive fashion.

2. The apparatus of claim 1, wherein the first communication means comprises a male fastening device and the second communication means comprises a female fastening device.

3. The apparatus of claim 1, wherein the first communication means comprises a female fastening device and the second communication means comprises a male fastening device.

4. The apparatus of claim 1, wherein the first communication means and the second communication means comprise a zipper.

5. The apparatus of claim 1, wherein the first communication means and the second communication means comprise a fabric hook-and-loop fastener system.

6. The apparatus of claim 1, wherein the first communication means and the second communication means comprise a button fastening system.

7. The apparatus of claim 1, wherein the first communication means and the second communication means comprise a snap fastening system.

8. An apparatus comprising:
a first side portion and a second side portion, each of the first side portion and the second side portion being disposed in a parallel relationship with each other;
a first end portion and a second end portion, the first end portion and the second end portion being disposed in a parallel relationship with each other and in a perpendicular relationship with each of the first side portion and the second side portion;
the first end portion having a first display surface and a first non-display surface, each of the first display surface being configured to be substantially displayed and the first non-display surface being configured to be substantially unseen;
the second end portion having a second display surface and a second non-display surface, the second display surface being configured to be substantially displayed and the second non-display surface being configured to be substantially unseen;
a first fringe portion disposed on the first display surface of the first end portion, the first fringe portion being disposed on an edge of the first display surface away from the center of the apparatus, the first fringe portion disposed in communication with the first end portion through a first communication means, the first communication being disposed on the first non-display surface;
a second fringe portion disposed on the second display surface of the second end portion, the second fringe portion being disposed on an edge of the second display surface away from the center of the apparatus, the second fringe portion disposed in communication with the second end portion through a second communication means, the second communication means being disposed on the second non-display surface;
wherein the first fringe portion is capable of being removed from the first end portion in a non-destructive fashion, and the second fringe portion is capable of being removed from the second end portion in a non-destructive fashion.
